(19) United States
(12) Patent Application Publication
(10) Pub. No.: US 2026/0138590 A1
(43) Pub. Date: May 21, 2026

(54) HYBRID ELECTRIC VEHICLE

(71) Applicant: TOYOTA JIDOSHA KABUSHIKI KAISHA, Toyota-shi (JP)

(72) Inventor: Hiroki SATO, Nishin-shi (JP)

(73) Assignee: TOYOTA JIDOSHA KABUSHIKI KAISHA, Toyota-shi (JP)

(21) Appl. No.: 19/257,935

(22) Filed: Jul. 2, 2025

(30) Foreign Application Priority Data
Nov. 15, 2024 (JP) 2024-199723

(51) Int. Cl. B60W 20/50; B60K 6/24; B60K 6/26; B60K 6/28; B60K 6/40; B60K 6/547; B60W 10/06; B60W 10/08; B60W 10/10; B60W 50/038

(52) U.S. Cl. CPC B60W 20/50; B60K 6/24; B60K 6/26; B60K 6/28; B60K 6/40; B60K 6/547; B60W 10/06; B60W 10/08; B60W 10/10; B60W 50/038; B60W 2510/0666; B60W 2510/081; B60W 2510/242; B60W 2510/305; B60W 2710/0666; B60W 2710/081; B60W 2710/1005; B60Y 2200/92; B60Y 2400/112; B60Y 2400/43; B60Y 2400/604; B60Y 2400/61; B60Y 2400/70

(57) ABSTRACT

Electric motor rotation speed control is executed such that when the rotation speed of the electric motor reaches a predetermined rotation speed or higher in the limp home mode in which a vehicle is travelling in a state in which the high-voltage battery is disconnected and the inverter that drives the electric motor is shut down, the automatic transmission device is controlled such that the gear stage of the automatic transmission device is upshifted, and the engine is controlled such that the torque output from the engine is increased when the torque output to the drive shaft is smaller than a target torque to be output to the drive shaft.

### CROSS-REFERENCE TO RELATED APPLICATION

This application claims priority to Japanese Patent Application No. 2024-199723 filed on Nov. 15, 2024. The disclosure of the above-identified application, including the specification, drawings, and claims, is incorporated by reference herein in its entirety.

### BACKGROUND

### 1. Technical Field

The present disclosure relates to a hybrid electric vehicle, and particularly, to a hybrid electric vehicle that includes an engine, an automatic transmission device, and an electric motor capable of generating power and attached to an input shaft of the automatic transmission device.

### 2. Description of Related Art

As this kind of hybrid electric vehicle, a hybrid electric vehicle including an engine, a first electric motor, a planetary gear mechanism, and a second electric motor that inputs and outputs power to and from a drive shaft has been proposed (for example, see Japanese Unexamined Patent Application Publication No. 2014-217112 (JP 2014-217112 A)). In the planetary gear mechanism, three rotation elements are connected to three axes of an output shaft of the engine, a rotation shaft of the first electric motor, and the drive shaft connected to a drive wheel. In the hybrid electric vehicle, the inverter is controlled by any one of the PWM control mode and the rectangular wave control mode according to the operation point of the second electric motor, and the rotation speed of the second electric motor is sometimes included in the limit rotation region including the switching point between the PWM control mode and the rectangular wave control mode. In that case, the amount of change in torque of the second electric motor is limited such that the second electric motor outputs torque within a range of an upper limit torque that is changed according to the rotation speed of the second electric motor.

### SUMMARY

In a hybrid electric vehicle including an engine, an automatic transmission device, and an electric motor capable of generating power and attached to an input shaft of the automatic transmission device, there is a case where a limp home mode is performed in which a battery is disconnected for travelling. In this case, an inverter that drives the electric motor using the power from the engine needs to be shut down in order to supply the power to an air conditioning device for air-conditioning a vehicle cabin or a low voltage system that operates a control device or an accessory. At the same time, because the inverter is shut down, the power generated by the electric motor needs to be stepped down by a DC/DC converter and supplied to the low voltage system. In this case, depending on the rotation speed of the electric motor, there is a need to operate the inverter in the rectangular wave control mode.

In a hybrid electric vehicle according to the present disclosure, the inverter that drives the electric motor can be maintained in the shutdown state in the limp home mode in which the battery is disconnected.

A hybrid electric vehicle according to the present disclosure is configured as follows.

A hybrid electric vehicle according to the present disclosure includes:
an engine;
an automatic transmission device including an input shaft connected to a crankshaft of the engine and an output shaft connected to a drive shaft connected to drive wheels;
an electric motor that is able to generate power and attached to the input shaft of the automatic transmission device;
a high-voltage battery configured to exchange power with the electric motor;
an inverter connected to a high-voltage side power line to which the high-voltage battery is connected, the inverter being configured to drive the electric motor;
a low-voltage battery having a lower rated voltage lower than the high-voltage battery;
a DC/DC converter connected between the high-voltage side power line and a low-voltage side power line to which the low-voltage battery is connected, the DC/DC converter being configured to exchange power between the high-voltage side power line and the low-voltage side power line with a change in voltage; and
a control device configured to control the engine, the electric motor, and the automatic transmission device.
   The control device is configured to execute electric motor rotation speed control such that, in a limp home mode in which the hybrid electric vehicle is travelling in a state in which the high-voltage battery is disconnected and the inverter is shut down, when a rotation speed of the electric motor reaches a predetermined rotation speed or higher, the automatic transmission device is controlled to upshift a gear stage of the automatic transmission device and when power output from the engine is smaller than target power, the engine is controlled to increase torque output from the engine.

In the hybrid electric vehicle of the present disclosure, there is a case where the rotation speed of the electric motor reaches a predetermined rotation speed or higher in the limp home mode in which the hybrid electric vehicle is travelling in a state in which the high-voltage battery is disconnected and the inverter that drives the electric motor is shut down. At that time, the automatic transmission device is controlled such that the gear stage of the automatic transmission device is upshifted. As a result, it is possible to suppress the rotation speed of the electric motor from being equal to or higher than the predetermined rotation speed, and to suppress switching control of the inverter in the rectangular wave control mode. When a rotation speed slightly lower than a rotation speed at which the electric motor needs to be controlled by the rectangular wave control is used as the predetermined rotation speed, it is possible to more reliably avoid switching control of the inverter in the rectangular wave control mode. As a result, the inverter that drives the electric motor can be maintained in the shutdown state in the limp home mode in which the battery is disconnected. When the power output from the engine is smaller than the target power at the time of such an upshift, the engine is controlled such that the torque output from the engine is increased. As a result, the upshift makes it possible to resolve an issue of insufficient power.

In the hybrid electric vehicle according to the present disclosure, the hybrid electric vehicle may further include an air conditioning device configured to perform air-conditioning of a vehicle cabin using the power from the high-voltage side power line. The control device may be configured to execute the electric motor rotation speed control when the air conditioning device is operated in the limp home mode in which the hybrid electric vehicle is travelling in a state in which the high-voltage battery is disconnected. That is, the electric motor rotation speed control may be executed solely when the air conditioning device is operated in the limp home mode in which the hybrid electric vehicle is travelling in a state in which the high-voltage battery is disconnected. In this way, it is possible to more reliably avoid a state that is likely to occur when the air conditioning device is operated, namely a state in which the inverter is switching-controlled in the rectangular wave control mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a schematic configuration of a hybrid electric vehicle 20 as an embodiment of the present disclosure; and

FIG. 2 is a flowchart showing an example of processing in a batteryless limp home mode executed by the HVECU 70.

### DETAILED DESCRIPTION OF EMBODIMENTS

Next, an embodiment for implementing the present disclosure will be described with reference to the embodiment.

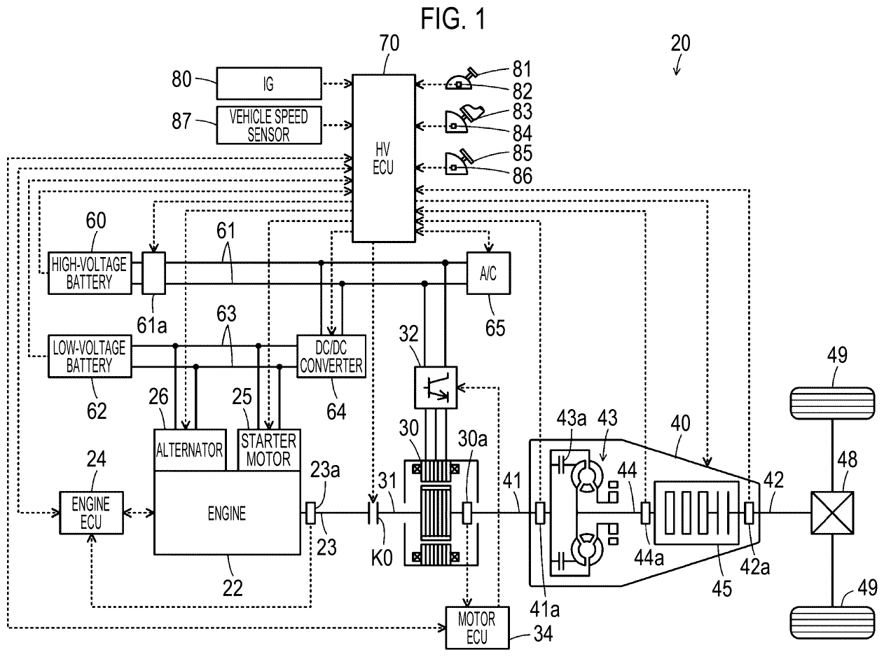

FIG. 1 is a configuration diagram showing a schematic configuration of a hybrid electric vehicle 20 as an embodiment of the present disclosure. The hybrid electric vehicle 20 of the embodiment includes an engine 22, a motor 30, an inverter 32, a clutch K0, and an automatic transmission device 40, as illustrated. The hybrid electric vehicle 20 of the embodiment includes a high-voltage battery 60, a low-voltage battery 62, a DC/DC converter 64, an air conditioning device 65, and a hybrid electronic control unit (hereinafter, referred to as “HVECU”) 70.

The engine 22 is configured as an internal combustion engine that outputs power by using fuel such as gasoline or light oil from a fuel tank. The crankshaft 23 of the engine 22 is connected to a rotation shaft 31 (rotor) of the motor 30 via a clutch K0. The engine 22 is operated and controlled by an engine electronic control unit (hereinafter, referred to as “engine ECU”) 24.

Although not shown, the engine ECU 24 includes a microcomputer having a CPU, a ROM, a RAM, a flash memory, an input/output port, and a communication port. The engine ECU 24 is input with signals from various sensors needed to control the operation of the engine 22 via an input port. Examples of the signal input to the engine ECU 24 include a crank angle θcr from a crank position sensor 23a that detects a rotation position of the crankshaft 23 of the engine 22. The coolant temperature Tw from a coolant temperature sensor (not shown) that detects the temperature of the coolant of the engine 22 can also be mentioned. The engine ECU 24 outputs various control signals for controlling the operation of the engine 22 via the output port. The engine ECU 24 is connected to the HVECU 70 via a communication port. The engine ECU 24 calculates the rotation speed Ne of the engine 22 based on the crank angle θcr of the crankshaft 23 from the crank position sensor 23a. The engine ECU 24 also calculates current output power Pe based on the rotation speed Ne, the intake air amount Qa, the fuel injection amount Qf, and the like.

A starter motor 25 for cranking the engine 22 and an alternator 26 that generates power using power from the engine 22 are connected to the crankshaft 23 of the engine 22. The starter motor 25 and the alternator 26 are connected to the low-voltage side power line 63 together with the low-voltage battery 62 and are controlled by the HVECU 70.

The motor 30 is configured as a synchronous motor generator, and includes a rotor in which a permanent magnet is embedded in a rotor core and a stator in which a three-phase coil is wound around a stator core. A rotation shaft 31 to which a rotor of the motor 30 is fixed is connected to a crankshaft 23 of the engine 22 via a clutch K0 and is connected to an input shaft 41 of the automatic transmission 45. The inverter 32 is used to drive the motor 30 and is connected to the high-voltage side power line 61. The motor 30 is rotationally driven by switching control of a plurality of switching elements of the inverter 32 by a motor electronic control unit (hereinafter, referred to as “motor ECU”) 34.

Although not shown, the motor ECU 34 includes a microcomputer having a CPU, a ROM, a RAM, a flash memory, an input/output port, and a communication port. The signals from various sensors are input to the motor ECU 34 via the input port. Examples of the signal input to the motor ECU 34 include a rotation position θm from a rotation position sensor 30a that detects a rotation position of a rotor (rotation shaft 31) of the motor 30. A phase current Iu, Iv from a current sensor that detects a phase current of each phase of the motor 30 can also be given. The motor ECU 34 outputs a control signal to the inverter 32 and the like via an output port. The motor ECU 34 is connected to the HVECU 70 via a communication port. The motor ECU 34 calculates the rotation speed Nm of the motor 30 based on the rotation position θm of the rotor (rotation shaft 31) of the motor 30 from the rotation position sensor 30a.

The clutch K0 is configured as, for example, a hydraulic friction clutch, is controlled by the HVECU 70, and connects and disconnects the rotation shaft 31 of the crankshaft 23 of the engine 22 and the motor 30.

The automatic transmission device 40 has a torque converter 43 and a six-speed automatic transmission 45. The torque converter 43 is configured as a general fluid transmission device. The torque converter 43 amplifies the torque of the power of the input shaft 41 connected to the rotation shaft 31 of the motor 30 and transmits the amplified torque to the transmission input shaft 44 that is the input shaft of the automatic transmission 45, or transmits the torque without amplification. The automatic transmission 45 has a transmission input shaft 44, an output shaft 42 connected to the drive wheels 49 via a differential gear 48, a plurality of planetary gears, and a plurality of hydraulic drive friction engagement elements (clutches, brakes). All the friction engagement elements have a hydraulic pressure servo including a piston, a plurality of friction engagement plates (a friction plate and a separator plate), an oil chamber to which hydraulic oil is supplied, and the like. The automatic transmission 45 forms forward gears or reverse gears from the first gear to the sixth gear by engaging and disengaging a plurality of friction engagement elements, and transmits power between the transmission input shaft 44 and the output shaft 42. The hydraulic pressure of the hydraulic oil from a mechanical oil pump or an electric oil pump is regulated and supplied to the clutch K0 or the automatic transmission 45 by a hydraulic pressure control device (not shown). The hydraulic pressure control device is controlled by the HVECU 70.

The high-voltage battery 60 is configured as, for example, a lithium ion secondary battery or a nickel-hydrogen secondary battery having a rated voltage of about several hundred V, and is connected to the high-voltage side power line 61 together with the inverter 32. A system main relay 61a that connects and disconnects the connection of the high-voltage battery 60 is attached to the vicinity of the high-voltage battery 60 of the high-voltage side power line 61. In addition, an air conditioning device 65 that air-conditions the cabin is connected to the high-voltage side power line 61. The air conditioning device 65 communicates with the HVECU 70. The low-voltage battery 62 is configured as, for example, a lead storage battery having a rated voltage of about 12 V or 14 V, and is connected to the low-voltage side power line 63 together with the starter motor 25 and the alternator 26. The DC/DC converter 64 is connected to the high-voltage side power line 61 and the low-voltage side power line 63. The DC/DC converter 64 steps down the power of the high-voltage side power line 61 to supply the power to the low-voltage side power line 63, or steps up the power of the low-voltage side power line 63 to supply the power to the high-voltage side power line 61 as needed.

Although not shown, the HVECU 70 includes a microcomputer having a CPU, a ROM, a RAM, a flash memory, an input/output port, and a communication port. Signals from various sensors are input to the HVECU 70 via input ports. Examples of the signal input to the HVECU 70 include a rotation speed Nin from the rotation speed sensor 41a attached to the input shaft 41 of the automatic transmission device 40 or a rotation speed Nmi from the rotation speed sensor 44a attached to the transmission input shaft 44 of the automatic transmission device 40. A rotation speed Nout from a rotation speed sensor 42a attached to the output shaft 42 of the automatic transmission device 40 can also be given. A voltage Vbh of the high-voltage battery 60 from a voltage sensor attached between terminals of the high-voltage battery 60, and a current Ibh of the high-voltage battery 60 from a current sensor attached to an output terminal of the high-voltage battery 60. A voltage Vbl from a voltage sensor attached between terminals of the low-voltage battery 62 can also be mentioned. An ignition signal from an ignition switch 80 and a shift position SP from a shift position sensor 82 that detects an operation position of a shift lever 81 can also be mentioned. An accelerator operation amount Acc from an accelerator pedal position sensor 84 that detects an amount of depression of an accelerator pedal 83, and a brake pedal position BP from a brake pedal position sensor 86 that detects an amount of depression of a brake pedal 85 can also be mentioned. The vehicle speed V from the vehicle speed sensor 87 can also be mentioned.

The HVECU 70 outputs various control signals via the output port. Examples of the signal output from the HVECU 70 include a control signal to the starter motor 25, a control signal to the alternator 26, and a drive control signal to the system main relay 61a. A control signal to the clutch K0 or the automatic transmission device 40 (hydraulic pressure control device), and a control signal to the DC/DC converter 64. The HVECU 70 is connected to the engine ECU 24 and the motor ECU 34 via a communication port. The HVECU 70 calculates the rotation speed ratio Gt of the automatic transmission device 40 by dividing the rotation speed Nin of the input shaft 41 of the automatic transmission device 40 from the rotation speed sensor 41a by the rotation speed Nout of the output shaft 42 of the automatic transmission device 40 from the rotation speed sensor 42a.

In the hybrid electric vehicle 20 of the embodiment configured as described above, the engine 22, the clutch K0, the motor 30, and the automatic transmission device 40 are controlled to travel in a hybrid traveling mode (HV traveling mode) or an electric traveling mode (EV traveling mode) by the cooperative control of the HVECU 70, the engine ECU 24, and the motor ECU 34. Here, the HV traveling mode is a mode in which the vehicle is travelling using the power of the engine 22 with the clutch K0 in the engaged state, and the EV traveling mode is a mode in which the vehicle is travelling without using the power of the engine 22 with the clutch K0 in the disengaged state.

In the control of the automatic transmission device 40 in the HV traveling mode or the EV traveling mode, the HVECU 70 first sets the target gear stage M* of the automatic transmission 45 based on the accelerator operation amount Acc and the vehicle speed V. Then, when the gear stage M of the automatic transmission 45 and the target gear stage M* coincide with each other, the automatic transmission 45 is controlled to hold the gear stage M. On the other hand, when the gear stage M and the target gear stage M* are different from each other, the automatic transmission 45 is controlled such that the gear stage M matches the target gear stage M*.

In the control of the engine 22 and the motor 30 in the HV traveling mode, the HVECU 70 first sets the required torque Tout* required for traveling (required for the output shaft 42 of the automatic transmission device 40) based on the accelerator operation amount Acc and the vehicle speed V. Next, a value obtained by dividing the required torque Tout* of the output shaft 42 by the rotation speed ratio Gt of the automatic transmission device 40 is set as a temporary required torque Tintmp of the input shaft 41 as a temporary value of the required torque Tin*. Then, a value obtained by performing a slow change process, such as a rate process or a smoothing process, on the temporary required torque Tintmp of the input shaft 41 is set as the required torque Tin* of the input shaft 41. In this way, when the required torque Tin* of the input shaft 41 is set, the target torque Te* of the engine 22 or the torque command Tm* of the motor 30 is set such that the required torque Tin* is output to the input shaft 41. The target torque Te* of the engine 22 is transmitted to the engine ECU 24, and the torque command Tm* of the motor 30 is transmitted to the motor ECU 34. When the target torque Te* is received, the engine ECU 24 performs the operation control of the engine 22 such that the target power Pe* calculated by the product of the target torque Te* and the rotation speed Ne is output from the engine 22. The operation control is, for example, an intake air amount control, a fuel injection control, or an ignition control. In a case where the torque command Tm* is received, the motor ECU 34 performs switching control of the switching elements of the inverter 32 such that the motor 30 is driven by the torque command Tm*.

In the control of the motor 30 in the EV traveling mode, the HVECU 70 sets the required torque Tin* of the input shaft 41 in the same manner as in the HV traveling mode. The HVECU 70 sets the torque command Tm* of the motor 30 such that the required torque Tin* is output to the input shaft 41, and transmits the torque command Tm* to the motor ECU 34. The motor ECU 34 performs switching control of a plurality of switching elements of the inverter 32 such that the motor 30 is driven by the torque command Tm*.

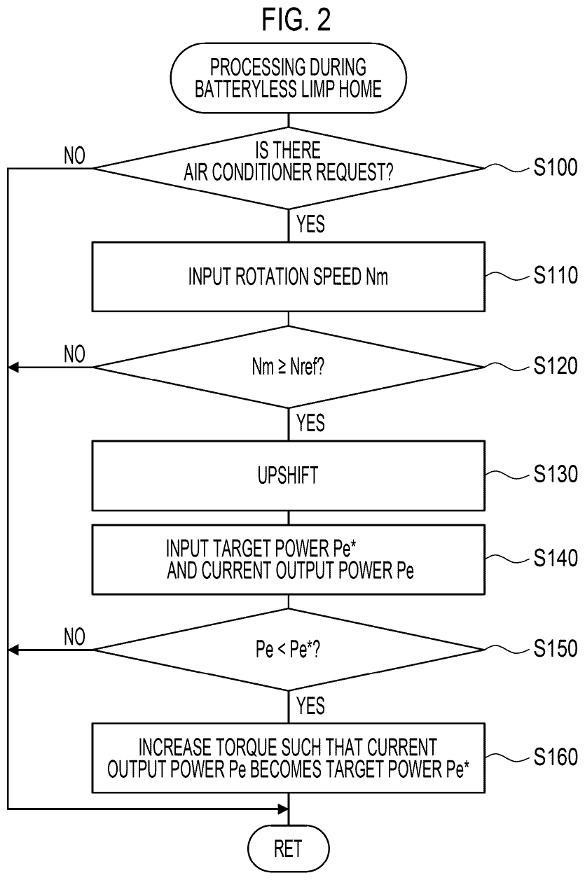

Next, the operation of the hybrid electric vehicle 20 of the embodiment configured as described above, particularly, the operation when the high-voltage battery 60 is disconnected by the system main relay 61a to perform the batteryless limp home mode is described. FIG. 2 is a flowchart showing an example of processing in a batteryless limp home mode executed by the HVECU 70. The batteryless limp home mode process is repeatedly executed in the batteryless limp home mode. In the batteryless limp home mode, the inverter 32 that drives the motor 30 is shut down.

When the processing in the batteryless limp home mode is executed, the HVECU 70 first determines whether there is an air conditioner request (S100). The air conditioner request is made when the air conditioning device 65 is turned on and is continued while the air conditioning device 65 is in operation. When the determination is made that the air conditioner request is not made, the air conditioning device 65 is not operated, and thus the present process is not needed, and the present process is terminated.

When determination is made in S100 that the air conditioner request is present, the rotation speed Nm of the motor 30 is input (S110), and determination is made whether the rotation speed Nm of the motor 30 is equal to or greater than a threshold value Nref (S120). Here, the threshold value Nref can use a rotation speed slightly lower than the lower limit rotation speed at which the inverter 32 that drives the motor 30 needs to be switching-controlled by the rectangular wave control mode. When determination is made that the rotation speed Nm of the motor 30 is equal to or higher than the threshold value Nref, the gear stage M of the automatic transmission device 40 is upshifted (S130). Due to this upshift, the rotation speed Nm of the motor 30 is less than the threshold value Nref. On the other hand, when determination is made that the rotation speed Nm of the motor 30 is less than the threshold value Nref, determination is made that the upshift is not needed, and the present process is terminated.

When the gear stage M of the automatic transmission device 40 is upshifted in S130, the target power Pe* and the current output power Pe are input (S140), and determination is made whether the current output power Pe is less than the target power Pe* (S150). When determination is made that the current output power Pe is less than the target power Pe*, the engine 22 is controlled such that the torque Te output from the engine 22 is increased such that the current output power Pe becomes the target power Pe* (S160), and the present process is terminated. As a result, the insufficient power can be eliminated by the upshift. On the other hand, when determination is made that the current output power Pe is equal to or higher than the target power Pe*, determination is made that the torque increase of the engine 22 is not needed, and the present process is terminated.

In the hybrid electric vehicle 20 described above, the high-voltage battery 60 is disconnected by the system main relay 61a to perform the batteryless limp home mode, and the rotation speed Nm of the motor 30 may be equal to or higher than the threshold value Nref while the air conditioning device 65 is operated. At that time, the gear stage M of the automatic transmission device 40 is upshifted. As a result, the rotation speed Nm of the motor 30 can be suppressed from being equal to or higher than the threshold value Nref and the inverter 32 can be suppressed from being switch-controlled by the rectangular wave control mode. As a result, the inverter 32 that drives the motor 30 during the avoidance traveling in which the high-voltage battery 60 is disconnected can maintain the shutdown state. When the current output power Pe is less than the target power Pe* at the time of such an upshift, the torque Te output from the engine 22 is increased such that the current output power Pe becomes the target power Pe*. As a result, the insufficient power can be eliminated by the upshift.

In the hybrid electric vehicle 20 of the embodiment, the batteryless limp home mode is performed, and there is a case where the rotation speed Nm of the motor 30 is equal to or higher than the threshold value Nref when the air conditioning device 65 is operated. At that time, the gear stage M of the automatic transmission device 40 is upshifted. However, even when the air conditioning device 65 is not in operation, the gear stage M of the automatic transmission device 40 may be upshifted when the rotation speed Nm of the motor 30 is equal to or higher than the threshold value Nref in the batteryless limp home mode. In this case, when the current output power Pe is less than the target power Pe* at the time of such an upshift, the torque Te output from the engine 22 may be increased such that the current output power Pe becomes the target power Pe*.

In the hybrid electric vehicle 20 of the embodiment, a six-speed automatic transmission 45 is provided. However, the vehicle may include an automatic transmission having four stages, five stages, eight stages, or the like.

In the hybrid electric vehicle 20 of the embodiment, the engine ECU 24, the motor ECU 34, and the HVECU 70 are provided. However, two of the above-described members may be integrally formed, or three of the above-described members may be integrally formed.

The correspondence between the main elements of the embodiment and the main elements of the disclosure described in the column of “SUMMARY” will be described. In the embodiment, the engine 22 corresponds to the “engine”, the automatic transmission device 40 corresponds to the “automatic transmission device” , and the motor 30 corresponds to the “electric motor”. The high-voltage battery 60 corresponds to a “high-voltage battery”, the inverter 32 corresponds to an “inverter”, and the low-voltage battery 62 corresponds to a “low-voltage battery”. The DC/DC converter 64 corresponds to a “DC/DC converter”, and the engine ECU 24, the motor ECU 34, and the HVECU 70 correspond to a “control device”.

The correspondence between the main elements of the embodiment and the main elements of the disclosure described in the column of “SUMMARY” is an example for specifically describing the embodiment for implementing the disclosure described in the column of “SUMMARY”. The disclosure described in the column of “SUMMARY” is not limited to the elements of the disclosure described in the column of “SUMMARY”. That is, the interpretation of the disclosure described in the column of “SUMMARY” should be made based on the description in the column, and the embodiment is merely a specific example of the disclosure described in the column of “SUMMARY”.

Although the embodiment for carrying out the disclosure has been described above with reference to the embodiment, the disclosure is not limited to the embodiment, and of course can be carried out in various modes within a scope without departing from the gist of the disclosure.

The present disclosure can be used in the manufacturing industry of a hybrid electric vehicle.

What is claimed is:

1. A hybrid electric vehicle comprising:
an engine;
an automatic transmission device including an input shaft connected to a crankshaft of the engine and an output shaft connected to a drive shaft connected to drive wheels;
an electric motor that is able to generate power and attached to the input shaft of the automatic transmission device;
a high-voltage battery configured to exchange power with the electric motor;
an inverter connected to a high-voltage side power line to which the high-voltage battery is connected, the inverter being configured to drive the electric motor;
a low-voltage battery having a lower rated voltage lower than the high-voltage battery;
a DC/DC converter connected between the high-voltage side power line and a low-voltage side power line to which the low-voltage battery is connected, the DC/DC converter being configured to exchange power between the high-voltage side power line and the low-voltage side power line with a change in voltage; and
a control device configured to control the engine, the electric motor, and the automatic transmission device, wherein
the control device is configured to execute electric motor rotation speed control such that, in a limp home mode in which the hybrid electric vehicle is travelling in a state in which the high-voltage battery is disconnected and the inverter is shut down, when a rotation speed of the electric motor reaches a predetermined rotation speed or higher, the automatic transmission device is controlled to upshift a gear stage of the automatic transmission device and when power output from the engine is smaller than target power, the engine is controlled to increase torque output from the engine.

2. The hybrid electric vehicle according to claim 1, further comprising an air conditioning device configured to perform air-conditioning of a vehicle cabin using the power from the high-voltage side power line, wherein the control device is configured to execute the electric motor rotation speed control when the air conditioning device is operated in the limp home mode in which the hybrid electric vehicle is travelling in a state in which the high-voltage battery is disconnected.

3. The hybrid electric vehicle according to claim 1, wherein the predetermined rotation speed is a rotation speed slightly lower than a rotation speed at which control of the electric motor by rectangular wave control is needed.
